(19) United States
(12) Patent Application Publication
(10) Pub. No.: US 2006/0054648 A1
(43) Pub. Date: Mar. 16, 2006

(54) Carrier rack for a four-wheeler

(76) Inventors: Donald J. Maguire, Dallas, GA (US); Gary B. Holtzclaw, Douglasville, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 10/942,201

(22) Filed: Sep. 16, 2004

(51) Int. Cl. B60R 9/00

(52) U.S. Cl. 224/401; 224/457; 224/42.32

(57) ABSTRACT

A carrier rack for attaching to a four-wheeler. The rack includes a first generally upright member for attaching to the front of the four-wheeler vehicle; a second generally upright member for attaching to the back of the four-wheeler vehicle; and a top portion connecting the first and second upright members. Additionally, the carrier rack can including a winch and game sling, hunting accessory racks, and a tool basket.

### TECHNICAL FIELD

The present invention relates generally to the field of four-wheeler or all terrain vehicles, and particularly to an attachment or carrier rack for a four-wheeler or all terrain vehicle that can haul equipment.

### BACKGROUND OF THE INVENTION

Many persons, such as farmers, ranchers, and hunters use ATV's to haul their equipment. For example, hunters prefer to use a four-wheeler vehicle, such as an all terrain vehicle (“ATV”), rather than to hike to an ideal hunting spot while carrying all of their hunting equipment. Similarly, some farmers and ranchers also prefer to use an ATV to carry their farming equipment.

However, a standard ATV typically does not have the space or cargo room to carry hunting or farming equipment or any game that the hunter has subsequently bagged, nor do standard ATV's offer the users any protection from inclement weather. Thus, those persons hitch a trailer to the back of an ATV for carrying such equipment and game. However, it is not always feasible to tow a trailer.

Thus it can be seen that needs exist for an attachment for a four-wheeler or all terrain vehicle that allows farmers, ranchers, and hunters, to name a few, to carry equipment and game without hauling a trailer behind the ATV, and optionally while protecting them from inclement weather.

### SUMMARY OF THE INVENTION

Briefly described, the present invention comprises a carrier rack for attachment to a vehicle. The carrier rack comprises a first generally upright member for attaching to the front of the vehicle; a second generally upright member for attaching to the back of the vehicle; and a top portion connecting the first and second upright members. Preferably, the top portion further comprises two generally U-shaped sections that connect together. More preferably, a pair of bolsters mates with open ends of the two generally U-shaped sections to reinforce their connection. Additionally, the carrier rack can further include at least one accessory rack secured to at least one of the generally upright members.

Optionally, the top portion can further include a solid roof, a plurality of upwardly extending projections, and/or a rail extending along a side thereof. Also optionally, the top portion can include a plate extending from a cross-member to an end of the top portion for attaching an accessory, such as a winch.

In another aspect, the present invention comprises a vehicle having a front portion, a rear portion, and a carrier rack for mounting to the front and the rear portions of the vehicle. The carrier rack includes a first portion for mounting to the front of the four-wheeler vehicle; a second portion for mounting to the rear of the four-wheeler vehicle; and a third portion for connecting the first portion to the second portion. Optionally, the four-wheeler can include a cover for encasing the frame and/or a roof. Additionally, the four-wheeler can include a winch.

In still another aspect, the present invention comprises a carrier rack for mounting to an ATV having a front rack and a rear rack. The carrier rack comprises a first generally U-shaped upright member having a base for attachment to the front rack of the ATV and first and second upright posts extending from ends of the base; a second generally U-shaped member having a base for attachment to the rear rack of the ATV and first and second upright posts extending from ends of the base; and a top portion comprised of first and second U-shaped members connected at open ends thereof to form a generally rectangular frame. The top portion is connected to the first and second generally U-shaped upright members by corner braces. The carrier rack can further include a winch mounted to the top portion and a game sling raised and lowered by the winch. Additionally, the carrier rack can further include at least one carrier hook for carrying a gun.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a carrier rack for a four-wheeler in accordance with an example embodiment of the present invention.

FIG. 2 is a side view of the carrier rack of FIG. 1, shown attached to a four-wheeler.

FIG. 3 is a front view of the carrier rack of FIG. 1, shown attached to a four-wheeler.

FIG. 4 is a top view of the carrier rack of FIG. 1, shown attached to a four-wheeler.

FIG. 5 shows unassembled components of the carrier rack of FIG. 1, arranged for compact packaging.

FIG. 6 is a side view of a carrier rack for a four-wheeler in accordance with another example embodiment of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

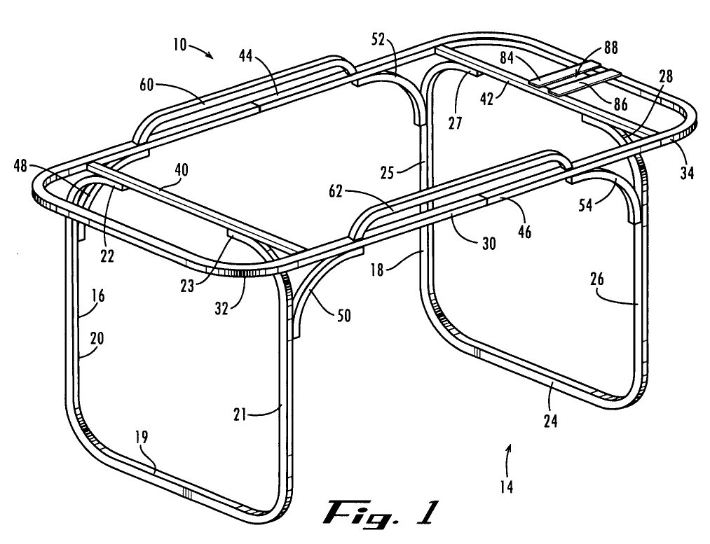

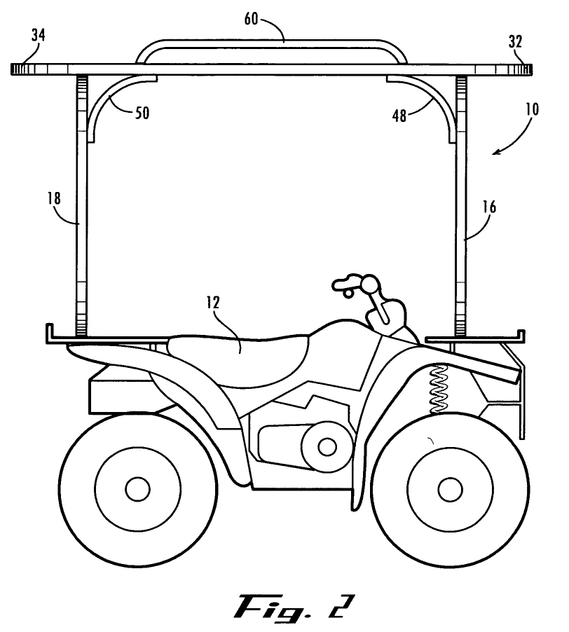

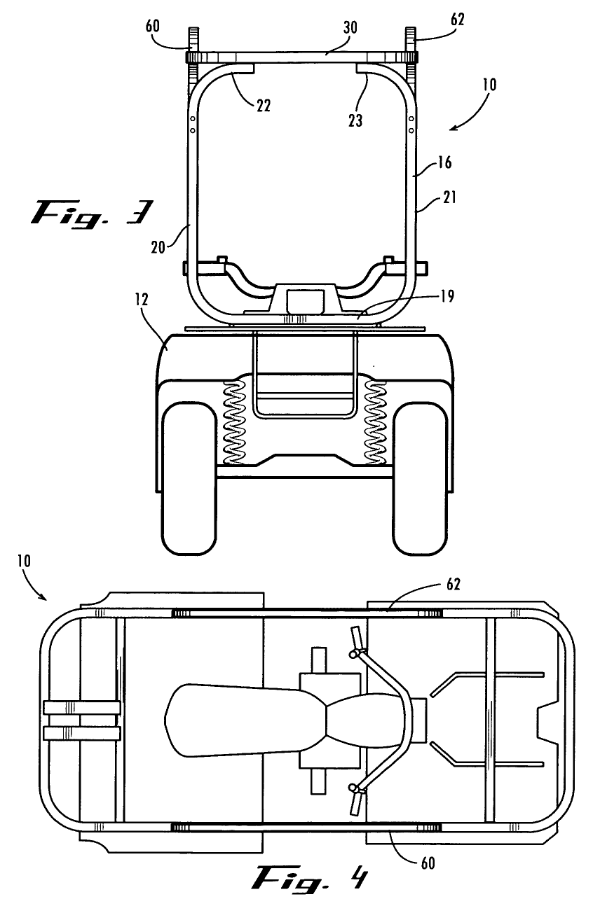

Referring to FIGS. 1-4, a carrier rack 10 for a four-wheeler 12 is described by way of an example embodiment. It should be noted that the carrier rack 10 can be adapted for use with any of a variety of all-terrain vehicles (“ATV”) or four-wheeler vehicles. Standard ATV's have front and rear racks to which the carrier rack 10 of the present invention can be mounted. In an example embodiment, the carrier rack 10 comprises a substantially rigid frame 14 having a first generally upright member 16 for mounting to the front of the four-wheeler 12 and a second generally upright member 18 for mounting to the back of the four-wheeler 12. Alternately, the first and second generally upright members 16 and 18 can be angled towards each other or away from each other when mounted to the four-wheeler 12. Preferably, the first and second upright members 16 and 18 are generally U-shaped or rectangular.

The first and second generally upright members 16 and 18 have base sections that attach to the ATV. The first generally upright member 16 has a base section 19 for attaching to the front rack of the ATV. Preferably, the base section 19 of the first generally upright member 16 is secured with a U-bolt. Alternately, the base section 19 can be secured with clamps, bolts, screws, or other fasteners. Extending from the ends of the base section 19 of the first member 16 is a pair of generally upright posts 20 and 21. Posts 20 and 21 have flanged ends 22 and 23 for attachment to a top portion 30. Similarly, the second generally upright member 18 has a base section 24 that is secured to ATV's rear rack with, preferably, a U-bolt. Alternately, the base section 24 can be secured to the ATV with clamps, screws, bolts, or other fasteners. Extending from the ends of the base section 24 is a pair of generally upright posts 25 and 26. Posts 25 and 26 have flanged ends 27 and 28 for attachment to the top portion 30.

Preferably, the top portion 30 is a generally rectangular member that attaches to the first and second members 16 and 18. More preferably, the top portion 30 comprises two generally U-shaped sections 32 and 34 that connect at their open ends, and are reinforced with mating bolsters 36 and 38 to form a generally rectangular shape. Preferably, the bolsters 36 and 38 are metal sleeves or bars that are about 22 inches long and approximately 34 inches wide and that slide within hollow ends of the U-shaped portions 32 and 34 so as to form an assembled top portion 30 with a generally rectangular shape. Also preferably, the U-shaped portions 32 and 34 are bolted to the bolsters 36 and 38 with 5/16″ bolts. Alternately, the U-shaped portions 32 and 34 can be attached to the bolsters 36 and 38 with other fasteners or fastening methods, including but not limited to, screws, snap-fittings, by welding, or the like.

Additionally, the top portion 30 has a first cross-member 40 and a second cross-member 42 extending between its sides 44 and 46. The first cross-member 40 extends between the sides 44 and 46 near the front of the four-wheeler, and the second cross-member 42 extends between the sides 44 and 46 near the back of the four-wheeler. The flanged ends 22, 23 of the first upright member 16 are secured to the first cross-member 40, and the flanged ends 27, 28 of the second upright member 18 are secured to the second cross-member 42, preferably with 5/16″ bolts, although other fasteners, such as screws or snap fittings, or methods of fastening, such as welding, can be employed as well. Additional cross-members can also be provided. Optionally, corner braces or supports 48, 50, 52, and 54 can be used to provide added rigidity and stability to the corners of the device. For example, the corner support 48 is secured to both the first member 16 near its flanged end and to the top portion 30 at a position near its outer periphery with, preferably, 5/16″ bolts, although other fasteners or methods of fastening may be employed as well. The other corner supports 50, 52, and 54 can be similarly attached between the top portion 30 and the ends of the upright members 16, 18.

Preferably, the frame 14 is constructed of one-inch, 14-gauge square steel tubes, although other durable materials such as, but not limited to, aluminum, fiberglass, wood, and plastic, of various sizes and cross-sectional shapes can be employed as well and are within the scope of the present invention. In an exemplary embodiment, the frame 14 is about 40 inches tall, so as to accommodate the seated height of an average adult user. However, it should be noted that the height of the frame 14 can differ and still be within the scope of the invention, although preferably, the height is about 40 inches or less, so as to avoid making the vehicle top-heavy when a load is carried on the frame. The top portion 30, when assembled into the generally rectangular structure, preferably has a length of about 80 inches, and a width of about 34 inches.

In an exemplary embodiment, the top portion 30 also includes a pair of rails extending along the sides 44 and 46 of the top portion 30 and/or along the front and back of the top portion. Preferably, the rails are about 40-54 inches long and are constructed of the 1″ square tubing, although other materials, shapes, and lengths are within the scope of the present invention. Alternately, a plurality of uprights can be used in lieu of or in addition to the rails. The rails and/or uprights can be used to tie down and hold equipment, tools, or other items that can be tied to the top portion 30, with for example, bungee cords, rope, or cord.

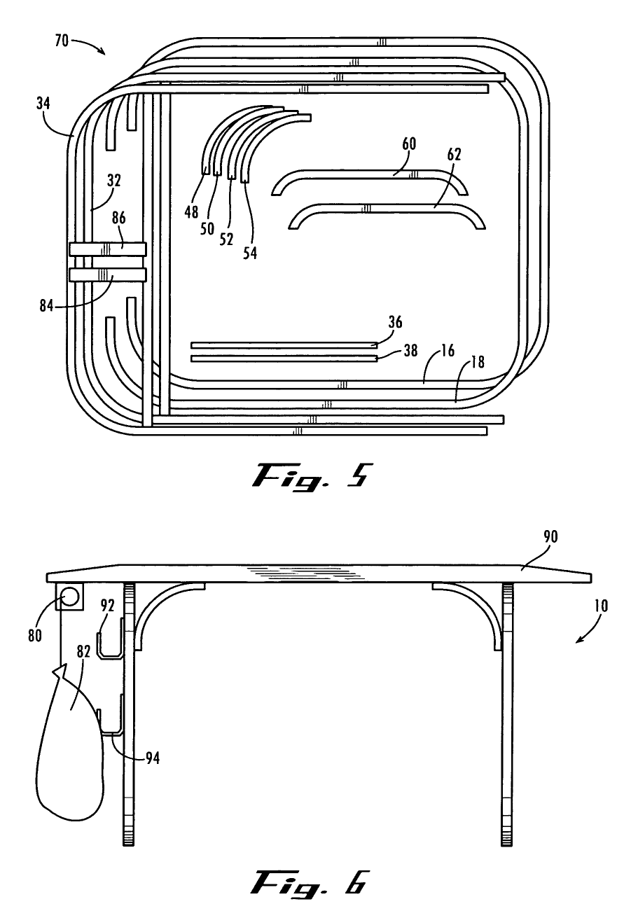

Preferably, the individual components of the carrier rack 10 are initially packaged unassembled in a compact kit 70, as best seen in FIG. 5, for ease of transport and for later assembly. The kit 70 preferably also includes fasteners such as nuts and bolts for assembling the various components and mounting the carrier rack 10 to the ATV. Additionally, tools such as wrenches can also be included in the kit 70, as well as any additional accessories, including those detailed herein, for the carrier rack 10.

Preferably, the top portion 30 also comprises a pair of mounting plates or bars 84 and 86 that extend from the second cross-member 42 near its center to near the center of the back of the top portion 30. Preferably, the bars 84 and 86 extend a distance away from the rear of the four-wheeler 12. Also preferably, the mounting bars 86 and 88 have an adjustable slot 88 therebetween for receiving a winch mount. By way of example and not limitation, the bars 84 and 86 can each be constructed of 14 gauge square-steel tube that is about 1″ tall, 1.5″ wide, and 10.5″ long. Also, the bars 84 and 86 extend from the cross member 42 to the back of the top portion, and are preferably parallel to one another with a slot 86 therebetween. In an example embodiment, the slot can be about ⅜″ wide, which would allow a winch 80 to slide for adjustability. A powered or manual winch 80 can optionally be secured to the plates 84 and 86 to assist the user in lifting a load. Preferably, the winch 80 includes a sling 82 for carrying large game such as deer. Alternately, the top portion 30 can comprises a single mounting plate or any number of mounting plates or bars for receiving a winch or other accessories.

Optionally, the carrier rack 10 also includes a roof 90, as more clearly seen in FIG. 6. The roof 90 can be constructed of molded plastic so as to provide protection from inclement weather and to provide added durability for securing tools or equipment to the roof. The roof 90 can be a hard top, comprising plastic, metal, or another durable weatherproof material, or a soft material such as canvas, that spans the length and width of the frame 14. Optionally, the roof 90 extends beyond the dimensions of the top portion 30 so as to provide an overhang.

The carrier rack 10 can optionally also include one or more accessory racks. As shown in FIG. 6, two accessory racks or hooks 92 and 94 are shown attached to the second upright member 18. The accessory racks 92 and 94 can be used to hold hunting equipment such as, for example, guns, bows, and arrows.

Also, the carrier rack 10 can be enclosed within a cover made of vinyl, canvas, or another weatherproof material that can provide additional protection from inclement weather. The cover preferably has transparent windows or openings therein for user visibility. Alternatively, the carrier rack 10 can also comprise windshields extending within the generally upright members 16 and 18.

A basket or toolbox that is, for example, about six to eight inches deep can optionally be secured to the carrier rack 10 to hold various items, including but not limited to, tools, hunting equipment, and the like. Preferably, the toolbox or basket is attached between the two generally upright posts of the rear generally U-shaped upright member 18. The toolbox can be constructed of one inch, 14 gauge square steel tubes and wrapped with a mesh material to prevent smaller items from falling out, but to allow dirt and water to escape. Alternately, the toolbox can be any size or shape and constructed of another durable material, and still be within the scope of the present invention.

While the invention has been shown and described in preferred forms, it will be apparent to those skilled in the art that many modifications, additions, and deletions can be made therein. For example, while the invention has been described as being particularly adapted to carrying hunting equipment and game, alternate embodiments of the invention are configured for carrying fishing equipment, construction tools, farming implements, and/or for any of a variety of purposes. These and other changes can be made without departing from the spirit and scope of the invention as set forth in the following claims.

What is claimed is:

1. A carrier rack for attachment to a vehicle, said carrier rack comprising:
a first generally upright member for attaching to the front of the vehicle;
a second generally upright member for attaching to the back of the vehicle; and
a top portion connecting the first and second upright members.

2. The carrier rack of claim 1, wherein the top portion further comprises two generally U-shaped sections that connect together.

3. The carrier rack of claim 2, wherein a pair of bolsters mates with open ends of the two generally U-shaped sections to reinforce their connection.

4. The carrier rack of claim 1, wherein the top portion comprises a solid roof.

5. The carrier rack of claim 1, wherein the top portion comprises a plurality of upwardly extending projections.

6. The carrier rack of claim 1, wherein the top portion comprises a rail extending along a side thereof.

7. The carrier rack of claim 1, wherein the top portion comprises a plate extending from a cross-member to an end of the top portion for attaching an accessory.

8. The carrier rack of claim 7, wherein the accessory is a winch.

9. The carrier rack of claim 1, further comprising at least one accessory rack secured to at least one of the generally upright members.

10. The carrier rack of claim 1, further comprising a toolbox attached to at least one of the generally upright members.

11. The carrier rack of claim 1, wherein at least one of the generally upright members is generally U-shaped and has flanged ends for attachment to the top portion.

12. The carrier rack of claim 1, wherein the carrier rack comprises four generally U-shaped sections in an unassembled configuration.

13. A vehicle having a front portion and a rear portion, comprising:
a carrier rack for mounting to the front and the rear portions of the vehicle, said carrier rack including:
a first portion for mounting to the front of the four-wheeler vehicle;
a second portion for mounting to the rear of the four-wheeler vehicle; and
a third portion for connecting the first portion to the second portion.

14. The four-wheeler vehicle of claim 13, further comprising a cover for encasing the frame.

15. The four-wheeler vehicle of claim 13, wherein the third portion comprises a roof.

16. The four-wheeler vehicle of claim 13, further comprising a winch.

17. The four-wheeler vehicle of claim 13, wherein the first and second portions each comprise generally U-shaped portions and the third portion comprises a pair of generally U-shaped portions for assembling together.

18. A carrier rack for mounting to an ATV, said ATV having a front rack and a rear rack, said carrier rack comprising:
a first generally U-shaped upright member having a base for attachment to the front rack of the ATV and first and second upright posts extending from ends of the base;
a second generally U-shaped member having a base for attachment to the rear rack of the ATV and first and second upright posts extending from ends of the base; and
a top portion comprised of first and second U-shaped members connected at open ends thereof to form a generally rectangular frame, said top portion connected to said first and second generally U-shaped upright members by corner braces.

19. The carrier rack of claim 18, further comprising a winch mounted to the top portion.

20. The carrier rack of claim 19, further comprising a game sling raised and lowered by said winch.

21. The carrier rack of claim 18, further comprised of at least one carrier hook for carrying a gun.
